(19) United States
(12) Patent Application Publication
(10) Pub. No.: US 2020/0109873 A1
(43) Pub. Date: Apr. 9, 2020

(54) SYSTEM AND METHOD FOR A THERMOSTAT ATTRIBUTE RECOGNITION MODEL

(71) Applicant: Emerson Electric Co., St. Louis, MO (US)

(72) Inventors: Thomas B. Lorenz, Chicago, IL (US); Abhishek Chakravarty, St. Louis, MO (US); Ralph Altmann, St. Louis, MO (US)

(21) Appl. No.: 16/155,553

(22) Filed: Oct. 9, 2018

(51) Int. Cl. F24F 11/48; G06K 9/00; G06K 9/32; G06K 9/46; G05B 19/042; F24F 11/63

(52) U.S. Cl. CPC F24F 11/48; G06K 9/00671; G06K 9/325; G06K 9/4652; F24F 2110/10; F24F 11/63; G06K 2209/01; G05B 2219/2614; G05B 19/042

(57) ABSTRACT

A thermostat replacement system includes a handheld user computing device having an image capture device. The handheld user computing device is configured to communicate to a network. Thermostat replacement system also includes a server computing device communicatively coupled to the network. The server computing device includes an image analyzer configured to identify image elements in an image captured by the handheld user computing device, and a machine learning algorithm that includes an image elements table of correspondence of learned thermostat configurations. The server computing device also includes a configurator configured to determine a wirelist for connecting existing thermostat wires to a replacement thermostat back plate using a replacement thermostat identification and the image elements table of correspondence.

### FIELD

The field of the disclosure relates generally to climate control systems and controllers, and more particularly to apparatus and methods for facilitating installation of replacement controllers.

### BACKGROUND

During replacement of a new electrical or electronic component such as, but not limited to a climate control system thermostat, wiring the climate control system thermostat with the proper wire configuration to correctly match the climate control system can be difficult. Currently, the installer visually identifies wires for an app on a smart phone or other computing device. From the existing wiring at the existing back plate, the app may assist in determining a proper installation of the existing wires at the new back plate. In some cases, wires may be misidentified or the lands or terminals on the new back plate may be misidentified, which may require manufacturer support to resolve.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

In one aspect, a thermostat replacement system includes a handheld user computing device having an image capture device. The handheld user computing device is configured to communicate to a network. Thermostat replacement system also includes a server computing device communicatively coupled to the network. The server computing device includes an image analyzer configured to identify image elements in an image captured by the handheld user computing device, and a machine learning algorithm that includes an image elements table of correspondence of learned thermostat configurations. The server computing device also includes a configurator configured to determine a wirelist for connecting existing thermostat wires to a replacement thermostat back plate using a replacement thermostat identification and the image elements table of correspondence.

In another aspect, a method of replacing an existing electronic component that includes a plurality of wires connected to a termination block with a replacement electronic component includes generating a color electronic image of the termination block including any wires connected thereto, analyzing the generated color electronic image to identify image elements of the generated color electronic image, and generating an image elements table of correspondence that includes a correlation between image elements identified as wires and image elements identified as language characters. The method also includes determining a configuration of the existing electronic component based on the image elements table of correspondence, generating a wirelist that correlates the image elements identified as wires and terminations on the replacement electronic component, and outputting the wirelist to a user.

In yet another aspect, a heating ventilating and air conditioning (HVAC) controller replacement system includes an HVAC controller configured to control one or more components of an HVAC system having a predetermined HVAC system configuration. The HVAC controller includes a user interface including a display, a memory, a communications interface configured to couple to a network, and an output block for providing one or more control signals to an associated HVAC system. The output block has a plurality of wiring terminals for accepting wires of the HVAC system wherein a wiring configuration between the wires of the HVAC system and the wiring terminals of the output block is dependent on an individual HVAC system configuration. HVAC controller replacement system also includes a handheld user computing device having a color electronic image capture device and an image analyzer configured to identify image elements of a captured color electronic image and determine a configuration of an existing HVAC controller based on the identified image elements. The image analyzer is also configured to generate a wirelist that correlates the identified image elements on the replacement HVAC controller and output the wirelist to the handheld user computing device.

Various refinements exist of the features noted above in relation to the various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of the present disclosure without limitation to the claimed subject matter.

### BRIEF DESCRIPTION OF THE DRAWINGS

FIG. 1 illustrates an exemplary embodiment of an apparatus for facilitating installation and/or connection of a thermostat or other controller embodying one or more aspects of the present disclosure.

FIG. 2 is schematic block diagram of a thermostat replacement system in accordance with an example embodiment of the present disclosure.

FIG. 3 is an example process flow for the thermostat replacement system shown in FIG. 2.

FIG. 4 is a portion of the machine learning algorithm shown in FIG. 2 that includes a neural network.

FIG. 5 is a flow diagram of a method of replacing an existing electronic component, such as, but not limited to, a climate control or HVAC thermostat with a replacement electronic component.

Although specific features of various embodiments may be shown in some drawings and not in others, this is for convenience only. Corresponding reference characters indicate corresponding parts throughout the drawings. Any feature of any drawing may be referenced and/or claimed in combination with any feature of any other drawing.

Unless otherwise indicated, the drawings herein are meant to illustrate features of embodiments of the disclosure. These features are applicable in a wide variety of systems including embodiments of the disclosure. As such, the drawings may not include all conventional features known by those of ordinary skill in the art to be required for the practice of the embodiments disclosed.

### DETAILED DESCRIPTION

The following detailed description illustrates embodiments of the disclosure by way of example and not by way of limitation. It is contemplated that the disclosure has general application to analytical and methodical embodiments of installing electrical and electronic components in industrial, commercial, and residential applications.

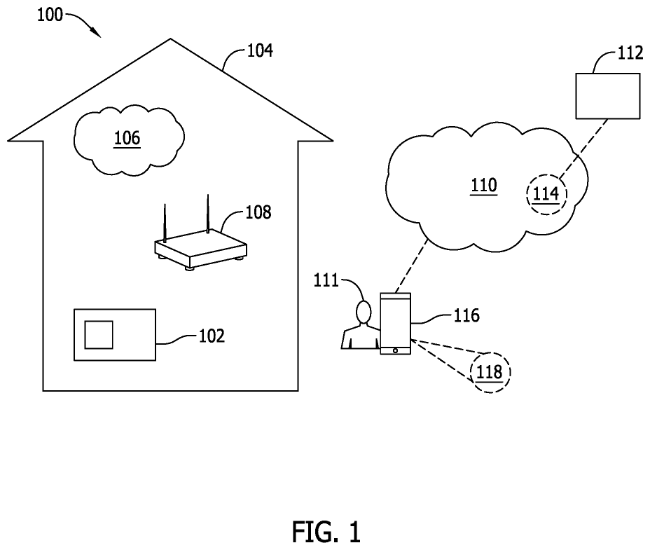

FIG. 1 illustrates an exemplary embodiment of an apparatus 100 for facilitating installation and/or connection of a thermostat or other controller embodying one or more aspects of the present disclosure. A thermostat 102 is provided for use in a structure 104, e.g., a residential building or a non-residential building, to control a climate control system of the structure 104. Thermostat 102 can be provisioned to communicate wirelessly in a user network 106 via a user network access point, e.g., a home network router 108 that provides wireless access to a wide-area network 110 such as the Internet and/or cellular network(s). In one example implementation a user 111, e.g., an owner or resident of the structure 104, obtains the wireless-communication-enabled thermostat 102, manufactured, e.g., by Emerson Electric Co. of St. Louis, Mo. In various embodiments, the thermostat 102 includes hardware, e.g., available from Qualcomm Incorporated, configured to enable the thermostat 102 to enter a “soft access point” (“soft AP”) mode in which the thermostat 102 can perform at least temporarily as an access point in a wireless network.

Apparatus 100 includes at least one computer 112, e.g., one or more servers, routers, personal computers, combinations of the foregoing, various combinations of processors and memory, etc. It should be noted that many different device configurations could be used to provide the capabilities described herein. In one example implementation, the computer(s) 112 are configured to provide energy information and energy management services through a web portal 114 available via the wide-area network 110. The web portal 114 may make such information and services available, e.g., to thermostat owners, installers, and other users. When, e.g., the thermostat 102 has been installed, a user may remotely access the thermostat 102, e.g., from a user communication device 116, which may be, e.g., a smartphone, an Internet-accessible laptop or desktop computer, a tablet, or other device.

As further described below, a user who is, e.g., an owner and/or an installer may utilize a user communication device 116 to facilitate installation of the thermostat 102 in the structure 104 and/or to facilitate provisioning of the thermostat 102 to the home network router 108. Other or additional types of devices may be used if configurable in accordance with one or more embodiments of the present disclosure. A user communication device 116 may include (without limitation) a mobile device such as a cellular or mobile phone, a smart phone such as a Blackberry®, an Android® device, an I-Phone® or I-Pad®, that can communicate using wireless communication, including but not limited to Wi-Fi, 802.11-based, WiMAX, Bluetooth, Zigbee, 3G, 4G, subscriber-based wireless, PCS, EDGE, and/or other wireless communication means, or substantially any combination thereof. The user communication device 116 has, or has access to, a software application 118 configured to perform various functions in accordance with various implementations of the disclosure. It should be noted generally that the term “software application” is to be interpreted broadly in the present disclosure. A “software application” can take many forms, including but not limited to source, object, and/or executable codes that can include and/or refer to a plurality of objects, modules, libraries, services, etc., and that can be stored, distributed, downloaded, combined and/or accessed in many different ways. In one example implementation, the software application 118 is loaded onto the communication device 116 by the computer(s) 112. The software application 118 may be written, e.g., in C++, development systems for Apple iOS, Android, etc. Implementations also are possible in which the user communication device 116 uses and/or communicates through web services and/or a web browser to implement the application 118. In some implementations the application 118, and/or execution of the application 118, may be distributed, e.g., among two or more computers located, e.g., in two or more geographic locations. In some embodiments the user communication device 116 may receive user input and send the input, e.g., to a server that has or has access to the application 118. The server may be included, e.g., in computer(s) 112 and may cause at least a portion of the application 118 to be executed to produce output, which may be sent, e.g., by the server to the user communication device 116. Additionally or alternatively, a user may access the application 118 via a browser of the user communication device 116.

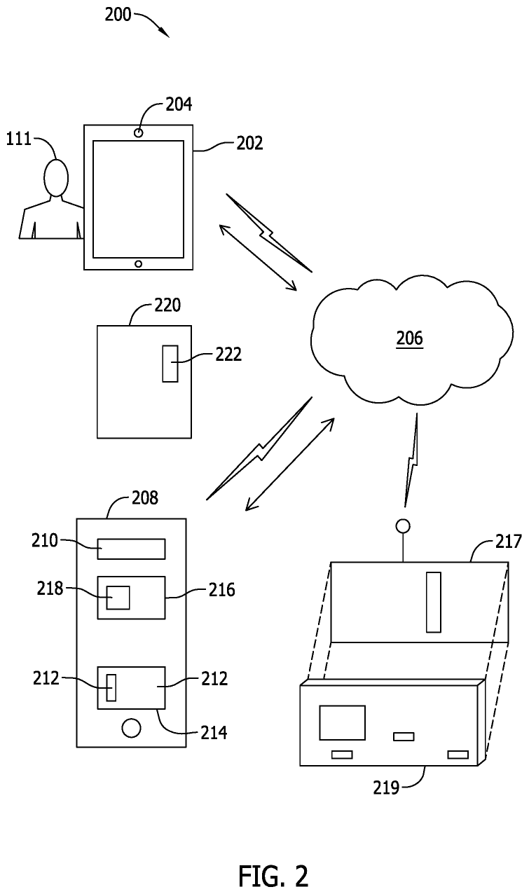

FIG. 2 is schematic block diagram of a thermostat replacement system 200 in accordance with an example embodiment of the present disclosure. In the example embodiment, thermostat replacement system 200 includes a handheld user computing device 202 having an image capture device 204. The handheld user computing device 202 is configured to communicate to a network 206, for example, the Internet.

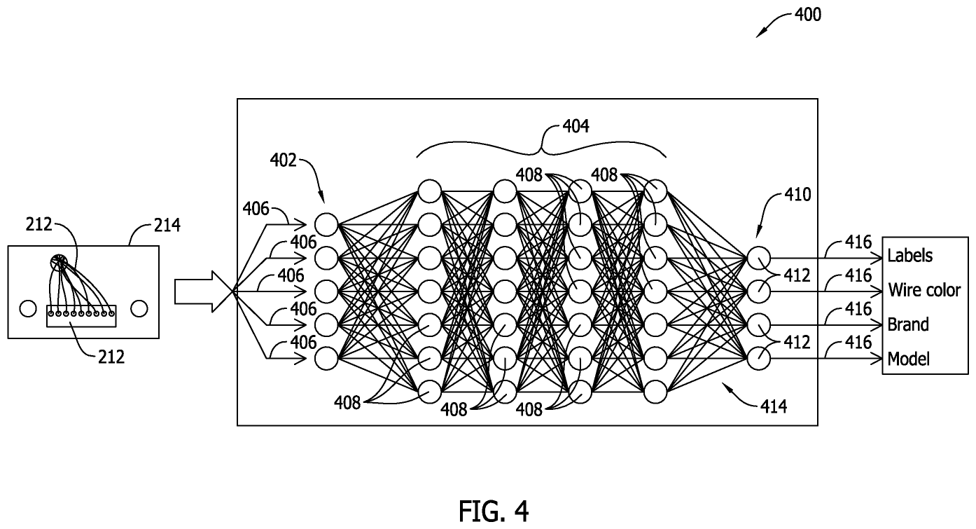

Thermostat replacement system 200 also includes a server computing device 208 communicatively coupled to network 206. Server computing device 208 includes an image analyzer 210 configured to identify and pre-process image elements 212 in an image 214 captured by handheld user computing device 202. Image analyzer 210 is configured to identify and pre-process wire image elements and language character elements in captured image 214. Such pre-processing is needed to initially train the machine learning algorithm with input images as well as expected output results. This step helps to train the machine learning model and minimizing prediction errors with new and unforeseen input data in the field. Server computing device 208 also includes a machine learning algorithm 216 that includes an image elements table of correspondence of learned thermostat configurations 218. In various embodiments, machine learning algorithm 216 includes a neural network (shown in FIG. 4). Image elements table of correspondence 218 includes a correlation between image elements 212 identified as wires and image elements 212 identified as language characters. Server computing device 208 is configured to request handheld user computing device 202 to prompt a user to acquire image 214 of a back plate 217 of a thermostat 219 to be replaced and to receive requested image 214.

Thermostat replacement system 200 also includes a configurator 220 configured to a determine wirelist 222 for connecting existing thermostat wires to a replacement thermostat back plate using a replacement thermostat identification and the image elements table of correspondence 218. In one embodiment, configurator 220 forms a part of server computing device 208. In other embodiments, configurator 220 forms a part of handheld user computing device 202.

Machine learning algorithm 216 and/or image analyzer 210 are configured to analyze a quality of the captured image and determine an accuracy score for determined wirelist 222. The analyzed quality and/or accuracy score may be used to request additional verifying information from the user or to inform the user of the question in quality or accuracy.

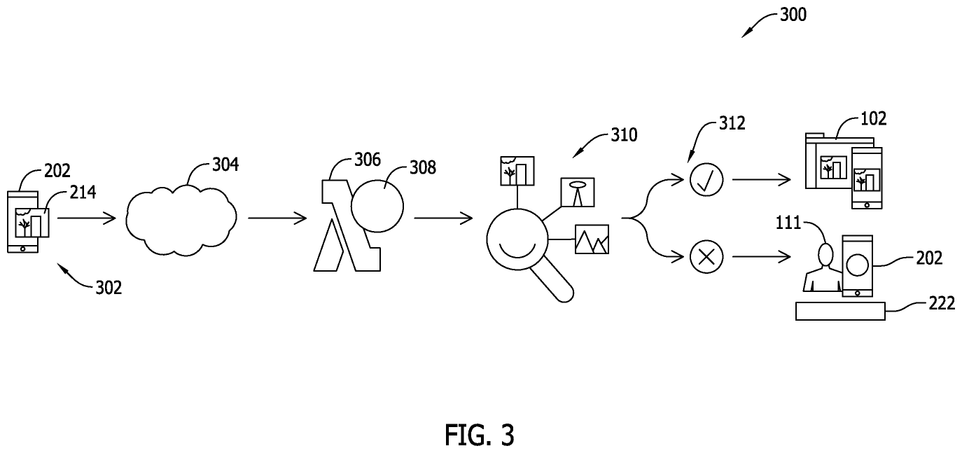

FIG. 3 is an example process flow 300 for thermostat replacement system 200. In the example embodiment, process flow 300 includes an input step 302 where the user uploads captured image 214 to, for example, a cloud-based or other storage 304. In various embodiments, a function such as, but not limited to a lambda function calls 306 a thermostat recognition model 308 executing for example, on image analyzer 210. Thermostat recognition model 308 is capable of identifying 310 text or other indicia that is useful for identifying a make and model number of the existing thermostat. Not only language text is used to identify the existing thermostat, but also graphics, such as, but not limited to trademark symbols. Wire colors and routing of wires is also identified. Based on machine learning techniques a quality and/or accuracy of the recognition are assessed 312 and an appropriate output is generated. The output may be embodied in wirelist 220 if a confidence of the recognition is high, as in a case where the quality and accuracy is high. If the confidence is high, wirelist 222 is transmitted to handheld user computing device 202. If the confidence does not meet a threshold range, user 111 may be prompted for additional information or may be directed to a reference webpage or other source of information to assist user 111 in making a correct determination for wiring replacement thermostat 102.

FIG. 4 is a portion of machine learning algorithm 216 (shown in FIG. 2) that includes a neural network 400. In the example embodiment, neural network 400 is configured to receive a plurality of inputs 212 from, for example, but not limited to image 214. Such inputs may include image elements 212 that have already been identified or neural network 400 may be used to identify image elements 212 in image 214. In various embodiments, image elements 212 may be identified as wires or terminal blocks, or may be identified as text to assist in identification of existing thermostat 102. Image 214 is channeled to an input layer 402 of neural network 400. A plurality of hidden layers 404 of neural network 400 are configured to receive inputs 406 from input layer 402. Each of a plurality of bias units 408 may receive outputs from a plurality of other bias units 408 and each of the plurality of bias units 408 may transmit outputs to a plurality of other bias units 408. An output layer 410 may have a plurality of output units 412 that each may receive a plurality of bias unit 408 outputs 414 from bias units 408 and then may transmit final outputs 416 that may include labels, wire colors, thermostat brand name, and thermostat model number.

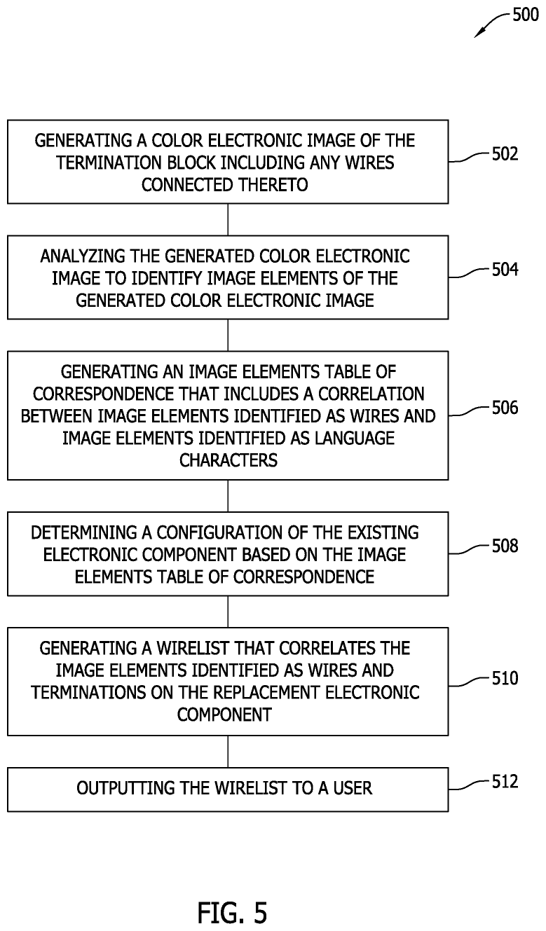

FIG. 5 is a flow diagram of a method 500 of replacing an existing electronic component, such as, but not limited to, a climate control or HVAC thermostat with a replacement electronic component. In the example embodiment, the electronic component includes a plurality of wires connected to a termination block. Method 500 includes generating 502 a color electronic image of the termination block including any wires connected thereto, which may include exposing the termination block to visual observation and capturing the image using, for example, a camera feature of a smartphone or tablet and analyzing 504 the generated color electronic image using for example, an image analyzer device to identify image elements of the generated color electronic image. In various embodiments, the image analyzer device includes an optical character recognition device that translates indicia on the termination block and/or back plate into electronic language characters. The image analyzer device may include a color element analyzer that identifies image elements by color. The image analyzer device may use color to trace an outline of the image elements and may then use a table stored in a memory of handheld user computing device or server computing device to recognize the image elements based on their similarity to stored image elements. The image elements could be any attribute or feature that can be used to identify the existing electronic component or to determine a configuration of a component or system the existing electronic component is connected to.

Method 500 also includes generating 506 an image elements table of correspondence that includes a correlation between image elements identified as wires and image elements identified as language characters and determining 508 a configuration of the existing electronic component or equipment connected to it based on the image elements table of correspondence. Method 500 further includes generating 510 a wirelist that correlates the image elements identified as wires and terminations on the replacement electronic component and outputting 512 the wirelist to a user.

Instructions that permit the implementation of method 500 may be stored on non-transitory computer-readable media communicatively coupled to a processor of at least one computer 112.

The logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the disclosure or its features may have different names, formats, or protocols. Further, the system may be implemented via a combination of hardware and software, as described, or entirely in hardware elements. Also, the particular division of functionality between the various system components described herein is merely one example, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the disclosure may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the disclosure. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device, and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “computer” and related terms, e.g., “computing device”, are not limited to integrated circuits referred to in the art as a computer, but broadly refers to a microcontroller, a microcomputer, a programmable logic controller (PLC), an application specific integrated circuit, and other programmable circuits, and these terms are used interchangeably herein.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

While the disclosure has been described in terms of various specific embodiments, it will be recognized that the disclosure can be practiced with modification within the spirit and scope of the claims.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 119 and by devices that include, without limitation, mobile devices, clusters, personal computers, workstations, clients, and servers, including RAM memory, ROM memory, EPROM memory, EEPROM memory, and non-volatile RAM (NVRAM) memory. The above memory types are examples only, and are thus not limiting as to the types of memory usable for storage of a computer program.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database.

As will be appreciated based on the foregoing specification, the above-described embodiments of the disclosure may be implemented using computer programming or engineering techniques including computer software, firmware, hardware or any combination or subset thereof, the technical effect of the methods and systems may be achieved by performing at least one of the following steps: (a) receiving, by each of the thermostat devices, a load shedding recovery notification, (b) selecting, by each thermostat device, a value that is unique to the thermostat device, (c) retrieving, from a memory of the thermostat device, a first time period value, (d) retrieving, from the memory of the thermostat device, a second time period value, (e) pseudo-randomly generating a primary time delay window using the selected unique value, the retrieved first time period value, and a first selectable set of randomization rules from a plurality of sets of randomization rules, (f) pseudo-randomly generating a secondary time delay window within the primary time delay window using the selected unique value, the retrieved second time period value, and a second selectable set of randomization rules from a plurality of sets of randomization rules, the first and second selectable sets of randomization rules are at least one of the same and different, and (g) restarting each of the plurality of independent autonomous conditioning units at a starting time that is delayed from the receipt of the load shedding recovery notification by an amount defined by the secondary time delay window. Any such resulting program, having computer-readable code means, may be embodied or provided within one or more computer-readable media, thereby making a computer program product, i.e., an article of manufacture, according to the discussed embodiments of the disclosure. The computer readable media may be, for example, but is not limited to, a fixed (hard) drive, diskette, optical disk, magnetic tape, semiconductor memory such as read-only memory (ROM), and/or any transmitting/receiving medium such as the Internet or other communication network or link, including a cloud computing and/or storage environment. The article of manufacture containing the computer code may be made and/or used by executing the code directly from one medium, by copying the code from one medium to another medium, or by transmitting the code over a network.

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A thermostat replacement system comprising:
a handheld user computing device comprising an image capture device, said handheld user computing device configured to communicate to a network; and
a server computing device communicatively coupled to said network, said server computing device comprising:
an image analyzer configured to identify and pre-process image elements in an image captured by said handheld user computing device;
a machine learning algorithm comprising an image elements table of correspondence of learned thermostat configurations; and
a configurator adapted to determine a wirelist for connecting existing thermostat wires to a replacement thermostat back plate using a replacement thermostat identification and the image elements table of correspondence.

2. The thermostat replacement system of claim 1, wherein said server computing device is configured to request the handheld user computing device prompt a user to acquire an image of a back plate of a thermostat to be replaced and to receive the requested image.

3. The thermostat replacement system of claim 1, wherein said image analyzer is configured to identify wire image elements and language character elements in the captured image.

4. The thermostat replacement system of claim 3, wherein the machine learning algorithm is configured to generate an image elements table of correspondence that includes a correlation between image elements identified as wires and image elements identified as language characters.

5. The thermostat replacement system of claim 1, wherein at least one of machine learning algorithm and the image analyzer are configured to analyze a quality of the captured image and determine an accuracy score for the determined wirelist.

6. The thermostat replacement system of claim 1, wherein said configurator forms a part of said server computing device.

7. The thermostat replacement system of claim 1, wherein said configurator forms a part of said handheld user computing device.

8. The thermostat replacement system of claim 1, wherein said machine learning algorithm comprises a neural network.

9. A method of replacing an existing electronic component with a replacement electronic component, the electronic component includes a plurality of wires connected to a termination block of the electronic component, said method comprising:
generating a color electronic image of the termination block including any wires connected thereto;
analyzing the generated color electronic image to identify image elements of the generated color electronic image;
generating an image elements table of correspondence that includes a correlation between image elements identified as wires and image elements identified as language characters;
determining a configuration of the existing electronic component based on the image elements table of correspondence;
generating a wirelist that correlates the image elements identified as wires and terminations on the replacement electronic component; and
outputting the wirelist to a user.

10. The method of claim 9, further comprising exposing the termination block to visual observation.

11. The method of claim 9, wherein analyzing the generated color electronic image comprises transmitting the generated color electronic image to an image analyzer device.

12. The method of claim 11, wherein transmitting the generated color electronic image to an image analyzer device comprises transmitting the generated color electronic image to an image analyzer device that includes a color element analyzer that identifies image elements by color.

13. The method of claim 11, wherein transmitting the generated color electronic image to an image analyzer device comprises transmitting the generated color electronic image to an image analyzer device that includes an optical character recognition device that translates indicia on the termination block into electronic language characters.

14. The method of claim 9, wherein replacing an existing electronic component with a replacement electronic component comprises replacing an existing thermostat with a replacement thermostat.

15. A heating ventilating and air conditioning (HVAC) controller replacement system comprising:
an HVAC controller configured to control one or more components of an HVAC system having a predetermined HVAC system configuration, the HVAC controller comprising:
a user interface including a display;
a memory;
a communications interface configured to couple to a network;
an output block for providing one or more control signals to an associated HVAC system, the output block having a plurality of wiring terminals for accepting wires of the HVAC system, a wiring configuration between the wires of the HVAC system and the wiring terminals of the output block is dependent on an individual HVAC system configuration;
a handheld user computing device comprising a color electronic image capture device,
an image analyzer configured to:
identify image elements of a first captured color electronic image;
determine a configuration of an existing HVAC controller based on the identified image elements;
generate a wirelist that correlates the identified image elements on the replacement HVAC controller; and
output the wirelist to the handheld user computing device.

16. The HVAC controller replacement system of claim 15, wherein the image analyzer is configured to generate an image elements table of correspondence that includes a correlation between image elements identified as wires and image elements identified as language characters.

17. The HVAC controller replacement system of claim 16, wherein said image analyzer comprises a neural network configured to generate the image elements table of correspondence.

18. The HVAC controller replacement system of claim 15, further comprising a remote server computing device, wherein said image analyzer resides on said remote server computing device.

19. The HVAC controller replacement system of claim 18, wherein at least one of said HVAC controller and said handheld user computing device are communicatively coupled to said remote server computing device through respective communication interfaces.

20. The HVAC controller replacement system of claim 15, wherein said image analyzer comprises an optical character recognition (OCR) section.

21. The HVAC controller replacement system of claim 15, wherein said image analyzer is further configured to transmit a prompt to said handheld user computing device to capture an image of said replacement HVAC controller after installation.

22. The HVAC controller replacement system of claim 15, wherein said image analyzer is further configured to:
receive a second captured color electronic image of the installed replacement HVAC controller; and
identify image elements of the second captured color electronic image.

23. The HVAC controller replacement system of claim 22, wherein said image analyzer is further configured to:
compare image elements of the first captured color electronic image to image elements of the second captured color electronic image; and
verify the image elements identified as wires in the second captured color electronic image are coupled to correct corresponding replacement HVAC controller terminations based on the image elements identified as wires and the image elements identified as language characters in the first and second captured color electronic images.

24. The HVAC controller replacement system of claim 22, wherein said image analyzer is further configured to:
compare image elements of the second captured color electronic image to the generated wirelist; and
verify the image elements identified as wires in the second captured color electronic image are coupled to correct corresponding replacement HVAC controller terminations based on the wirelist.
